(19) United States
(12) Patent Application Publication
(10) Pub. No.: US 2026/0358558 A1
(43) Pub. Date: Nov. 12, 2026

(54) INTEGRATED PHOTONIC CIRCUIT FOR DEMULTIPLEXING A HIGHLY MULTIMODE INCIDENT OPTICAL BEAM AND FOR RECOMBINATION

(71) Applicant: THALES, MEUDON (FR)

(72) Inventors: Jérôme BOURDERIONNET, PALAISEAU (FR); Vincent BILLAULT, PALAISEAU (FR); Arnaud BRIGNON, PALAISEAU (FR)

(21) Appl. No.: 19/142,065

(22) PCT Filed: Dec. 15, 2023
(86) PCT No.: PCT/EP2023/086031

§ 371 Date: Jun. 20, 2025

(30) Foreign Application Priority Data
Dec. 22, 2022 (FR) 2214236

(51) Int. Cl. G02B 6/125; G02B 6/12; G02B 6/293; G02B 6/30

(52) U.S. Cl. CPC G02B 6/125; G02B 6/12007; G02B 6/29316; G02B 6/305; G02B 2006/12164

(57) ABSTRACT

A planar photonic circuit for demultiplexing a multimode incident optical beam into a plurality of single-mode sub-beams includes a guiding layer, the planar photonic circuit including: an integrated diffractive device including a coupling diffraction grating or two superimposed coupling diffraction gratings, configured to couple the multimode optical beam into the guiding layer of the planar photonic circuit and to generate two or four diffracted beams, an integrated conversion device including zones of free propagation, a zone of free propagation being associated with each of the diffracted beams, a plurality of collecting waveguides arranged downstream of each zone of free propagation, and a plurality of single-mode waveguides, a collecting waveguide being coupled to a single-mode waveguide so as to generate said plurality of single-mode sub-beams.

### CROSS-REFERENCE TO RELATED APPLICATIONS

This application is a National Stage of International patent application PCT/EP2023/086031, filed on Dec. 15, 2023, which claims priority to foreign French patent application No. FR 2214236, filed on Dec. 22, 2022, the disclosures of which are incorporated by reference in their entireties.

### FIELD OF THE INVENTION

The invention relates to the field of optical communications using a spatial multimode propagation channel. This is notably the case in free space, where the phase front of the information vector wave is distorted to a greater or lesser extent by passage through a disturbed medium, such as an atmospheric layer in an earth-satellite link. According to another example, propagation through a multimode fiber induces disturbance of the beam as a result of coupling between the spatial modes.

The invention relates more particularly to a planar photonic circuit comprising the functionalities necessary for spatial demultiplexing of the incident beam, that is to say collection of the multimode incident beam and decomposition thereof into a plurality of single-mode optical beams. The invention also relates to a planar photonic circuit integrating the functionalities of recombination and detection/processing of single-mode beams.

### BACKGROUND

One problem to be solved for optical communications, when the phase front of an information-carrying optical beam is distorted by passage through free space, is that of maintaining an optimum link budget despite these disturbances.

If this degraded beam were to be coupled directly to a single-mode guide, a large majority of the energy on the other spatial modes would be lost and the signal-to-noise ratio would be highly degraded. In addition, due to atmospheric disturbances, energy may quickly change from one mode to another. In the case of single-mode detection, huge fluctuations in coupled intensity (up to 30 dB for example) take place, whereas when recovering and summing the energy of each of the modes, these fluctuations in coupled energy are hugely reduced. It is thus sought to recover the maximum number of possible spatial modes contained in the degraded beam in order to recover the maximum amount of energy and thus improve the signal-to-noise ratio.

To achieve this at reception, one solution consists in collecting and then transforming a multimode beam into multiple single-mode beams, this operation being carried out by a spatial demultiplexing device 14. The various single-mode beams are then recombined, and then processed/detected. The spatial demultiplexing device is thus inserted into a reception system, 3 non-limiting examples of which are given below.

The first example illustrated in FIG. 1 illustrates a reception system SR1 for the case of a WDM link in which, at emission, a beam consisting of M multiplexed wavelengths λ₁, λ₂, . . . λ_{M}, (index j varying from 1 to M) emitted by lasers L1, L2, LM, each carrying a modulation signal (modulators mod1, mod2, etc. and multiplexer λ_{MUX}), is emitted into free space. After propagation through the atmosphere FS, the beam has a highly distorted amplitude and phase, forming the incident beam Fid at reception. The reception system SR1 comprises the spatial demultiplexer 14, which decomposes the multimode beam Fid into a plurality of N single-mode beams Fi (i varying from 1 to N). The single-mode beams are then recombined coherently by a recombiner 20, which generates a recombined beam Frecomb. The sum beam Frecomb is then demultiplexed by a wavelength demultiplexing device λ_{DEMUX} so as to form M beams at M wavelengths λⱼ each constituting an information transport channel. The M beams are then each sent to M detectors PD₁, PD₂, . . . . PD_{M} (for M WDM channels). M electrical signals S_{λj} are recovered at the output of the detectors, one per wavelength. This is a coherent recombination reception system that exhibits very good recombination efficiency over a wide spectral band or frequency comb (WDM architecture). Document US 2020-0195355 describes such a reception system and coherent recombiner component architecture 20 able to be integrated into a planar photonic circuit.

The second example illustrated in FIG. 2 relates to incoherent detection in which the reception system SR2 also comprises the spatial demultiplexer 14, which decomposes the multimode beam Fid into a plurality of N single-mode beams Fi. Each single-mode beam Fi is coupled to a demultiplexer λ_{DEMUX} and the beams at each wavelength λj are detected by N×M photodetectors PDi,j. Electrical links carry out the summing over i of all of the signals coming from the detectors PDij at the wavelength λj. M electrical signals S_{λj} are recovered at the end of the summing, one per wavelength.

The third example illustrated in FIG. 3 illustrates a single-wavelength coherent detection system SR3, for example used in the field of telecommunications, in the case of coherent optical communications to provide very high data transmission rates. The beam emitted by the laser L1 at λ1 is both amplitude-modulated and phase-modulated by way of two modulators mod,I and mod,Q. The reception system SR3 comprises the spatial demultiplexer 14 and the coherent recombiner 20. The recombined signal is then mixed by a mixer 24 with a signal coming from a local oscillator OL. The mixer is typically a multimode interference coupler (MMI) component. For conventional coherent detection, mixing the signal with a local oscillator gives access to the amplitude of the electric field through a beat on a balanced photodiode. In the field of coherent optical communications, information encoded on both the in-phase and quadrature field (I and Q) is needed. In this case, illustrated in FIG. 3, there is coherent detection for the in-phase signal (I) on one balanced detector PDb (electrical output signal S_{I}) and coherent detection for the detection of the quadrature signal (Q) on another balanced detector (electrical output signal S_{Q}). The 2 to 4 MMI (two inputs: the signal and the local oscillator) directly generates the mixture of the 2 signals with the appropriate phases. This particular modulation format has the broadest data transmission capacity, but is all the more sensitive to atmospheric disturbances.

All of the reception systems described above require a spatial demultiplexer 14, which is available in multiple architectures known to a person skilled in the art.

According to a first example described in document EP3100095, spatial sampling of the incident beam is carried out according to a pre-established base of spatial modes (for example Hermite-Gaussian) by successive passage through phase plates and sections of free propagation. This demultiplexer therefore consists of discrete optical elements, is passive, and does not include components for detection. A commercial product has been derived from this patent (TILBA) and has been combined with an integrated photonic circuit for coherent recombination and detection of single-mode beams (V. Billault, et al. “Free space optical communication receiver based on a spatial demultiplexer and a photonic integrated coherent combining circuit,” Opt. Express 29, 33134-33143 (2021)).

According to a second example described in document US20150086157, the spatial demultiplexer carries out adiabatic tapering of single-mode fibers to a multimode core fiber. This full-fiber solution is of interest, but there are only a few commercial products, and these offer only a few spatial modes (3 or 6 for the product from Optoscribe).

The main drawback of these two approaches is that they are relatively bulky and cannot be integrated on a photonic circuit. It is necessary to combine them with other external components, with the connection problems this entails, to implement more complex functions (recombination, detection), thereby making the final system not particularly compact and less robust to the environment.

A third example, described in the publication by Watanabe et al. “Coherent few mode demultiplexer realized as a 2D grating coupler array in silicon.” (Optics Express 28.24 (2020): 36009-36019), describes an integrated photonics device for generating and receiving low-order spatial modes for coupling to a few-mode fiber FMF, illustrated in FIG. 4. Low-order spatial modes are understood to mean only the LP₀₁, LP₁₁ₐ and LP_{11b} modes. E₀₁, E₁₁ₐ, E_{11b} denote the projections of the incident field onto each of these modes. A few-mode optical fiber is understood to mean a fiber through which a number of spatial modes (per x or y polarization) less than or equal to 4 propagate.

The disclosed technique consists in juxtaposing 4 two-dimensional coupling gratings G1, G2, G3 and G4 in the form of a 2×2 array (see FIG. 4A). This decomposition into 4 gratings thus makes it possible to process, separately and independently, 4 spatial zones of light incident on the demultiplexer. Since all non-Gaussian modes have spatial lobes that are symmetrical about one or two axes (x and/or y) and have opposite amplitude, the integral of overlap between a non-Gaussian mode and a diffraction grating to a single-mode guide is generally close to zero: non-Gaussian modes are not coupled into the guiding layer. By processing 4 spatial zones separately, this structure makes it possible to collect the intensity of 4 lobes of an optical wave incident on the integrated circuit. This structure thus makes it possible to process the projections E₀₁, E₁₁ₐ, E_{11b} (see FIG. 4B). This system cannot be extrapolated to a higher number of spatial modes. Each of the 4 gratings is also the superposition of 2 orthogonal gratings. Each grating Gi is coupled respectively to 2 perpendicular single-mode guides MC (mode coupler) in order to collect the corresponding rectilinear and orthogonal polarizations. The incident beam leaving the multimode fiber is thus coupled to 8 single-mode guides via the 4 gratings G1 to G4. The signal propagating through each of the 8 single-mode guides is then mixed with an LO signal from a local oscillator by way of an MMI in order to carry out coherent I,Q detection on each of the channels. This device has the advantage of being integrated on a photonic circuit, but it is designed for a few-mode fiber and does not allow a number of spatial modes greater than 4 to be processed.

### SUMMARY OF THE INVENTION

One aim of the present invention is to rectify the abovementioned drawbacks by proposing a planar photonic circuit comprising an integrated spatial demultiplexer capable of processing numerous spatial modes of a highly multimode incident beam. The integration of the demultiplexer also makes it possible to carry out all of the processing on one and the same planar photonic circuit, including the recombination and detection of single-mode beams.

The present invention relates to a planar photonic circuit for demultiplexing a multimode incident optical beam into a plurality of single-mode sub-beams, comprising a guiding layer, the planar photonic circuit comprising:
an integrated diffractive device comprising a coupling diffraction grating or two superimposed coupling diffraction gratings, configured to couple the multimode optical beam into the guiding layer of the planar photonic circuit and to generate two or four diffracted beams,
an integrated conversion device comprising:
   zones of free propagation, a zone of free propagation being associated with each of the diffracted beams, the conversion device furthermore being configured such that a diffracted beam diverges as it propagates through the associated zone of free propagation,
   a plurality of collecting waveguides arranged downstream of each zone of free propagation and
   a plurality of single-mode waveguides,
a collecting waveguide being coupled to a single-mode waveguide and being configured to adiabatically transform a fraction of the multimode optical beam collected locally by said collecting waveguide into an optical beam in a fundamental mode of said single-mode waveguide, so as to generate said plurality of single-mode sub-beams (Fi).

According to a first embodiment, the diffractive device comprises a single diffraction grating having plane fringes and generating two diffracted beams propagating in two opposite directions, and the conversion device comprises two divergent lenses positioned on the respective paths of the two diffracted beams upstream of the zones of free propagation.

According to a second embodiment, the diffractive device comprises two diffraction gratings having perpendicular plane fringes, and each configured to generate two diffracted beams propagating in two opposite directions, and the conversion device comprises four divergent lenses positioned on the respective paths of the four diffracted beams upstream of the zones of free propagation.

According to a third embodiment, the diffractive device comprises two diffraction gratings having plane fringes and each configured to generate a single diffracted beam and so that said two diffracted beams propagate in two non-collinear and non-orthogonal directions, and the conversion device comprises two divergent lenses positioned on the respective paths of the two diffracted beams upstream of the zones of free propagation.

According to a fourth embodiment, the diffractive device comprises two diffraction gratings having curved fringes and each configured to generate a single diffracted beam and so that said two diffracted beams propagate in two non-collinear and non-perpendicular directions.

According to one embodiment, the planar photonic circuit according to the invention furthermore comprises an integrated device for combining and detecting said single-mode sub-beams, comprising at least one photodetector.

According to one embodiment, the integrated combining and detecting device furthermore comprises a plurality of delay lines configured to equalize the optical or mixed optical/electrical paths of the single-mode sub-beams, considered from the position of the one or more superimposed diffraction gratings and to a location where a signal carrying information associated with a single wavelength and integrating the contribution of all of the single-mode sub-beams is generated.

According to one embodiment, the integrated combining and detecting device comprises:
a plurality of wavelength demultiplexers respectively coupled to the plurality of single-mode waveguides,
a plurality of photodetectors coupled to the outputs of said demultiplexers,
electrical tracks configured to sum, for each wavelength, the signals coming from the photodetectors.

According to one embodiment, said location is the one for which the electrical summing includes all of the signals coming from the photodetectors associated with one and the same wavelength.

According to one embodiment, the combining and detecting device comprises:
a plurality of elementary coherent recombination devices arranged in cascades so as to obtain a recombined beam, the single-mode waveguides being coupled in pairs to the elementary coherent recombination devices of the first stage of said cascade,
a wavelength demultiplexer,
a plurality of photodetectors coupled to the outputs of the demultiplexer.

According to one embodiment, the elementary coherent recombination device comprises an integrated interferometer comprising a first and second phase shifter element.

According to one embodiment, said location is the output of the wavelength demultiplexer.

According to one embodiment, the combining and detecting device furthermore comprises a mixer configured to mix the recombined beam with a local oscillator, the photodetector being a balanced photodetector.

According to one embodiment, the mixer has 4 outputs coupled to two balanced photodetectors so as to carry out in-phase and quadrature detection.

The following description presents a number of exemplary embodiments of the device of the invention: these examples do not limit the scope of the invention. These exemplary embodiments not only contain the features essential to the invention but also additional features associated with the embodiments in question.

### BRIEF DESCRIPTION OF THE DRAWINGS

The invention will be better understood and other features, aims and advantages thereof will become apparent from the following detailed description, which is provided with reference to the appended drawings, which are given by way of non-limiting examples and in which:

FIG. 1, already cited, illustrates a first example of emission/reception on a WDM link according to the prior art, in which, at emission, a beam consisting of M multiplexed wavelengths each carrying a modulation signal is emitted into free space and, at reception, coherent recombination takes place.

FIG. 2, already cited, illustrates a second example of emission/reception on a WDM link according to the prior art, in which, at reception, recombination is incoherent.

FIG. 3, already cited, illustrates a single-wavelength emission/reception system with in-phase and quadrature coherent detection according to the prior art.

FIGS. 4A and 4B already cited, illustrate an integrated photonics device for generating and receiving spatial modes for coupling to a few-mode fiber according to the prior art.

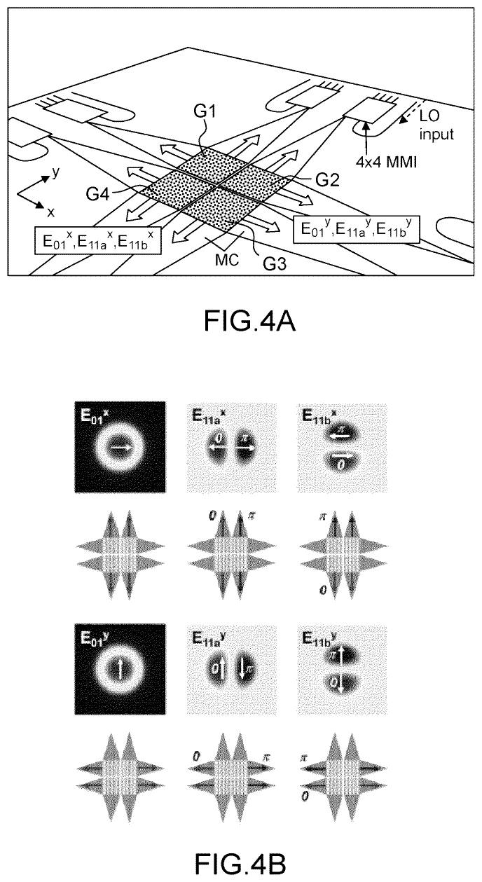

FIG. 5 illustrates the planar photonic circuit (PIC) according to the invention.

FIG. 6 illustrates a first variant of the PIC according to the invention in which the diffractive device comprises a single diffraction grating having plane fringes and generating two diffracted beams propagating in two opposite directions.

FIG. 7 illustrates the single-direction diffraction of an incident beam spatially structured along what is referred to as the transverse direction Y perpendicular to the diffraction direction X and incident with an oblique incidence.

FIG. 8 illustrates the single-direction diffraction of an incident beam spatially structured along what is referred to as the longitudinal direction X (diffraction direction X) and incident with an oblique incidence.

FIG. 9 illustrates a double diffraction in opposite directions of a beam structured along X and incident on the grating with normal incidence.

FIG. 10 illustrates a second variant of the PIC according to the invention in which the diffractive device comprises two superimposed diffraction gratings having plane and perpendicular fringes and each configured to generate two diffracted beams propagating in two opposite directions.

FIG. 11 illustrates a third variant of the PIC according to the invention in which the diffractive device comprises two diffraction gratings having plane fringes and each configured to generate a single diffracted beam and so that the two diffracted beams propagate in two non-collinear and non-orthogonal directions.

FIG. 12 illustrates a fourth variant of the PIC according to the invention in which the diffractive device comprises two diffraction gratings each having curved fringes and each configured to generate a single diffracted beam and so that said two diffracted beams propagate in two non-collinear and non-orthogonal directions.

FIG. 13 illustrates one embodiment of the PIC according to the invention in which the planar photonic circuit furthermore comprises an integrated device for combining and detecting said single-mode sub-beams.

FIG. 14 illustrates one embodiment for which incoherent recombination is carried out.

FIG. 15 illustrates the cascade architecture of the coherent recombination.

FIG. 16 illustrates an elementary coherent recombination device according to the prior art.

FIG. 17 illustrates a planar photonic circuit according to the invention that carries out spatial demultiplexing on 16 single-mode beams and coherent recombination with interferometers as illustrated in FIG. 16.

### DETAILED DESCRIPTION

The invention relates to a planar photonic circuit PIC for demultiplexing a highly multimode incident optical beam into a plurality of single-mode sub-beams.

The complex multimode beam to be processed is any beam. It results for example from degradation caused by propagation through the atmosphere of an initially Gaussian emitted beam or an optical fiber, as explained above. The optical beam incident on the device furthermore typically initially originates from an optical source modulated by a communication signal, and has passed through a non-homogeneous free-space propagation channel or has been injected into a multimode fiber and has propagated through same. Propagation through the atmosphere or through the fiber distorts the phase profile and amplitude profile of the beam. The beam incident on the PIC according to the invention is therefore highly spatially multimode and is preferably collimated or focused in order to illuminate the diffractive device Ddiff. Highly multimode is understood to mean a beam that comprises at least N=5 spatial modes per polarization, typically between 5 and 30 spatial modes. The PIC according to the invention comprises a guiding layer GL, parallel to the substrate Sub, through which light propagates.

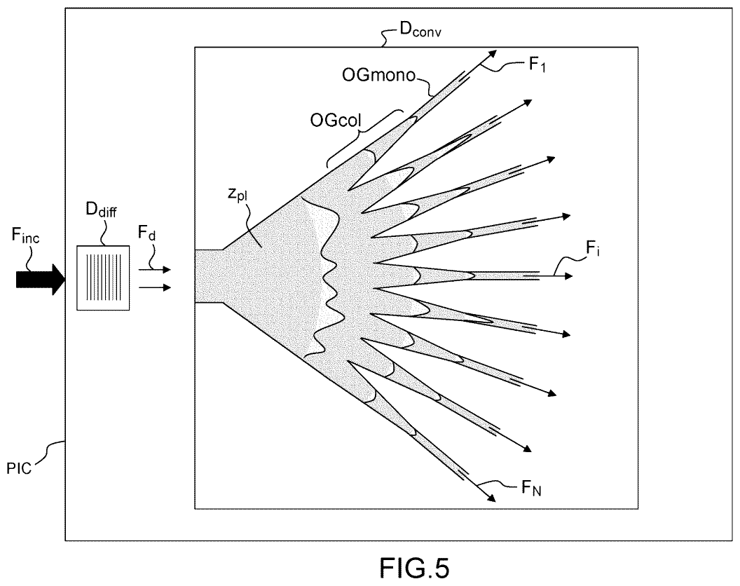

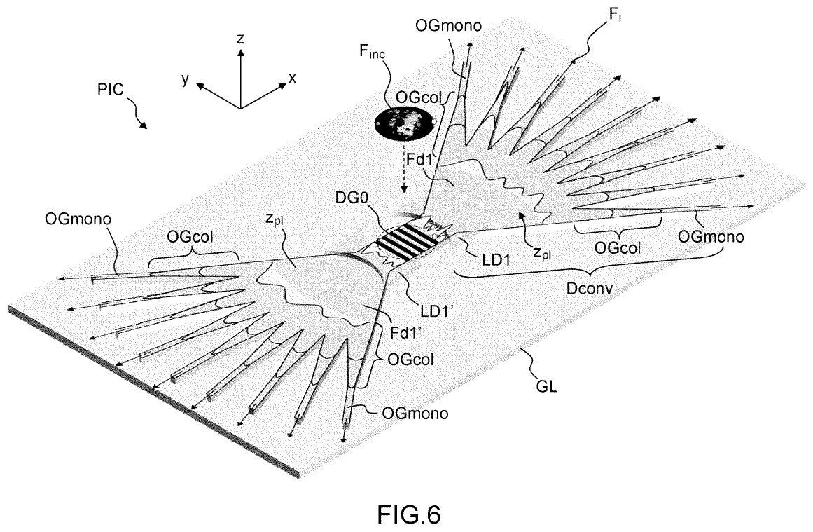

The principle of the PIC according to the invention is illustrated in FIG. 5. It comprises a diffractive device Ddiff integrated into the circuit that comprises a coupling diffraction grating or two superimposed coupling diffraction gratings, the one or more gratings being configured to couple the multimode incident optical beam Finc into the guiding layer GL of the planar photonic circuit and to generate two or four diffracted beams. Only one diffracted beam Fd is illustrated in FIG. 5, and the following FIGS. 6, 10, 11 and 12 illustrate various variants of generating two or four diffracted beams. The diffracted beams originating from the incident beam are spatial multimodes. The incident beam may have one or more wavelengths or a given spectral band. The demultiplexer according to the invention operates on the proviso that the one or more wavelengths are diffracted with sufficient efficiency by the one or more diffraction gratings.

The PIC, also called a photonic chip, also comprises an integrated conversion device Dconv comprising zones of free propagation Zpl for the diffracted beams, a zone of free propagation being associated with each of the diffracted beams. The PIC also comprises a plurality of collecting waveguides OGcol arranged downstream of each zone of free propagation, and a plurality of single-mode waveguides OGmono, each collecting waveguide being coupled to a single-mode waveguide (and vice versa), so as to generate the plurality of single-mode sub-beams Fi, i varying from 1 to N. FIG. 5 illustrates only one zone of free propagation, associated with the beam Fd.

Four variants of the PIC according to the invention are described below, without limitation.

The one or more diffraction gratings are Bragg gratings having alternating fringes with the refractive index of the guiding layer. These gratings are usually used to couple a single-mode beam, which is typically Gaussian, from free space to a waveguide on a photonic chip. They diffract the incident beam in the guiding layer GL of the PIC and in one or more directions given by the one or more wave vectors of the one or more gratings. The diffraction of the 2-dimensional electromagnetic field incident on the diffractive device results in one or more one-dimensional projections of the 2D field of Finc into the plane of the integrated circuit. Each of these 1D projections is spatially multimode.

The conversion device Dconv converts the 1D multimode projections of Finc into the plane of the integrated circuit into a plurality of single-mode guided beams Fi of different phases and amplitudes. The one or two Bragg gratings couple the incident multimode beam to a plurality of multimode guides (the collecting guides). To this end, the diffracted beam is made to diverge in the plane of the photonic chip (zones of free propagation Zpl) and collecting guides OGcol are placed on the path of the divergent diffracted beam in order to sample the beam spatially. There is therefore a zone Zpl and a plurality of guides OGcol associated with each diffracted beam. The conversion device is thus configured such that a diffracted beam diverges as it propagates through the associated zone of free propagation. This divergence is for example achieved with a sub-wavelength structure (referred to as a metamaterial) configured to bring about an effective index variation that makes it possible to obtain a divergent lens function. For example, holes or grooves of variable dimensions are dug out to create the effective index variation. A “divergent lens” is thus understood to mean any structure or element that makes it possible to make the diffracted beam diverge.

Each of the diffracted beams propagating through the associated zone of free propagation Zpl is multimode. The single-mode extractions are then carried out, via the association of a collecting guide OGcol, which each collect a fraction of the multimode beam propagating through the zone Zpl so as to send it to an associated single-mode guide OGmono.

On the upstream side of the guide OGcol, each collecting guide collects a fraction of the multimode wavefront (amplitude/phase) propagating through Zpl. Each of the collecting guides OGcol adiabatically transforms this fraction of the multimode optical beam collected locally by the collecting guide, referred to as multimode light, into an optical beam propagating in the fundamental mode (downstream of the guide). Fundamental mode is understood to mean the lowest-order mode. The number of collecting guides defines the resolution of the spatial sampling of multimode light. The minimum resolution required depends on the number of modes of the incident light. Thus, to efficiently sample the multimode wavefront, the number of guides OGcol is chosen to be at least as great as the number of modes in the 1D multimode projections into the zone of free propagation Zpl.

In the collecting guide, the energy that was in the various modes initially present in the upstream part of the guide has been transferred to a single mode present in the downstream part, the fundamental mode. There is therefore a high modal rejection rate on the downstream side. A single-mode waveguide is arranged in the extension (downstream side) of the associated collecting waveguide and is configured to transport this fundamental mode, which constitutes the single-mode sub-beam Fi.

In other words, the collecting guide transforms the collected multimode light into light propagating in the fundamental mode of the associated single-mode waveguide.

According to one preferred embodiment, the collecting waveguide has a width that decreases in the direction of propagation (referred to as taper mode, funnel-shaped), illustrated in FIG. 5.

According to another embodiment, the collecting waveguide has a flared shape, that is to say a width that increases in the direction of propagation (an inverse taper, tip shape on the upstream side).

It is thus not the physical width of the section of the collecting guide that is significant, rather the size of the fundamental mode, which must decrease in the direction of propagation.

According to one embodiment, the collecting guides are contiguous (upstream side, that is to say on the side of the zone of free-space propagation) so as to recover all of the light of the divergent diffracted beam. Contiguous collecting guides are preferably in taper mode (decreasing width), as illustrated in FIG. 5.

According to one embodiment, the single-mode guides OGmono all have the same width. The modes carried by these guides are intended to be recombined, and it is therefore preferable for the single-mode guides to all have the same width for ease of combination.

According to one embodiment, the initial width/geometry of the collecting guides is adapted to the statistics of the modes most present in the incident beam.

With the PIC according to the invention, it is not sought to multiplex and/or demultiplex the spatial modes of a few-mode fiber, but the largest quantity of energy of a spatially distorted beam, with a high modal content, is collected on a photonic circuit.

The advantage of the invention is that of offering a PIC that integrates a spatial mode demultiplexer. For this purpose, an original spatial demultiplexer architecture comprising Ddiff and Dconv is proposed. The multimode incident beam is decomposed into a plurality of single-mode components that are integrated into the PIC and are also available for processing in integrated fashion, without any connection or addition of external components, the processing being carried out, in one preferred mode, in the same photonic circuit (see below).

A first variant of the circuit PIC according to the invention is illustrated in FIG. 6. In this variant, the diffractive device Ddiff comprises a single diffraction grating DG0 having plane fringes and generating two diffracted beams Fd1, Fd1′ propagating in two opposite directions (bidirectional diffraction). There are therefore two zones of free propagation Zpl here, one per diffracted beam. To allow the collecting guides to carry out spatial sampling, the conversion device Dconv furthermore comprises two divergent lenses LD1, LD1′ positioned on the respective paths of the two diffracted beams Fd1 and Fd1′ upstream of the zones of free propagation Zpl. Letting N be the number of single-mode guides OGmono, there are N/2 guides per direction here. In this variant, the incident beam preferably illuminates Ddiff with a normal incidence so that the Bragg condition is verified for the two opposite propagation directions.

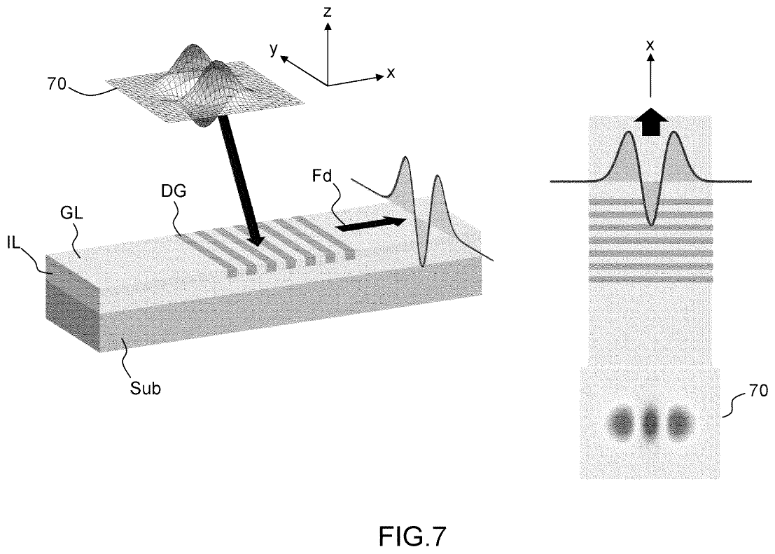

The benefit of having two opposite diffraction directions for a grating DG is illustrated in FIGS. 7 to 9. FIG. 7 illustrates the single-direction diffraction only (diffracted beam Fd) of an incident beam 70 spatially structured along what is referred to as the transverse direction Y perpendicular to the diffraction direction X and incident with an oblique incidence, for which the Bragg condition is verified. The circuit PIC has a guiding layer GL of index ng, a substrate Sub of index n0 and an intermediate layer IL of intermediate refractive index nᵢₙₜ<ng. The diffracted beam Fd coupled into the guiding layer GL of the integrated circuit PIC reproduces the structuring of the beam.

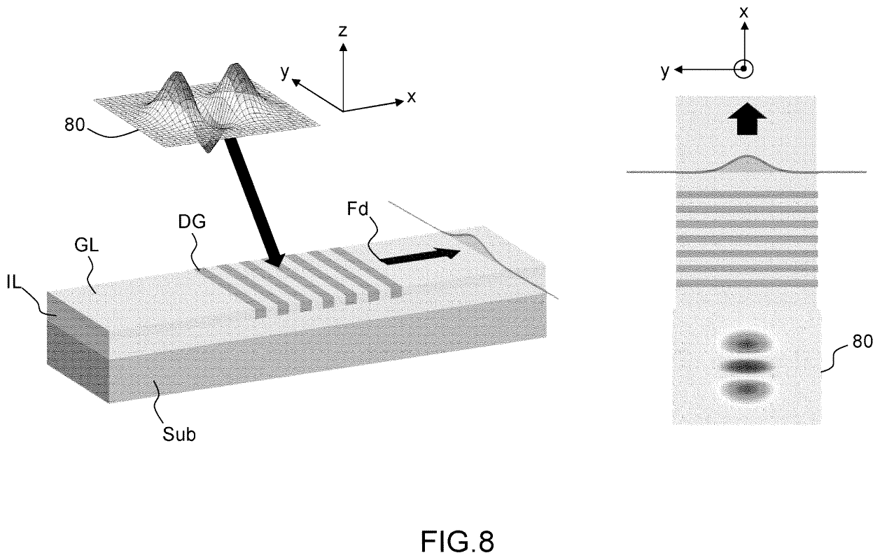

FIG. 8 illustrates the single-direction diffraction only (diffracted beam Fd) of an incident beam 80 spatially structured along what is referred to as the longitudinal direction X (diffraction direction X) and incident with an oblique incidence, for which the Bragg condition is verified. The diffracted beam Fd coupled into the guiding layer GL of the integrated circuit PIC has an energy proportional to the integral of overlap between the beam structuring profile in the diffraction direction and the diffraction profile of the grating. The coupling of the beam Fd into the “middle” guiding layer, and thus the structuring of the beam, and part of the energy associated with this mode is lost. Single-direction diffraction alone is therefore sub-optimal for beams structured in the diffraction direction, or even totally ineffective for certain types of modes.

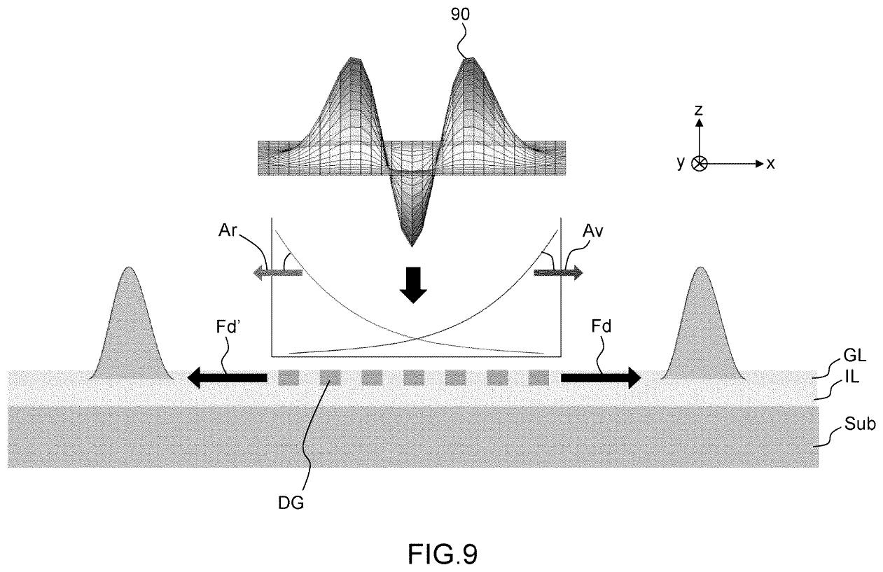

FIG. 9 illustrates the case of double diffraction (beams Fd and Fd′) in opposite directions of a beam 90 structured along X and incident on the grating DG with normal incidence. The diffraction profile of the grating, which decreases exponentially, is shown on the curves respectively on the left for the direction of propagation toward the rear of the grating Ar and on the right for the diffraction toward the front Av. Diffraction by the grating toward both the front and rear directions gives an additional degree of freedom for decomposing the spatial structuring of the incident beam. The integral of overlap between the beam structuring profile and the diffraction profile of the grating in the two directions generates two beams Fd and Fd′ with a total energy far greater than single-direction diffraction.

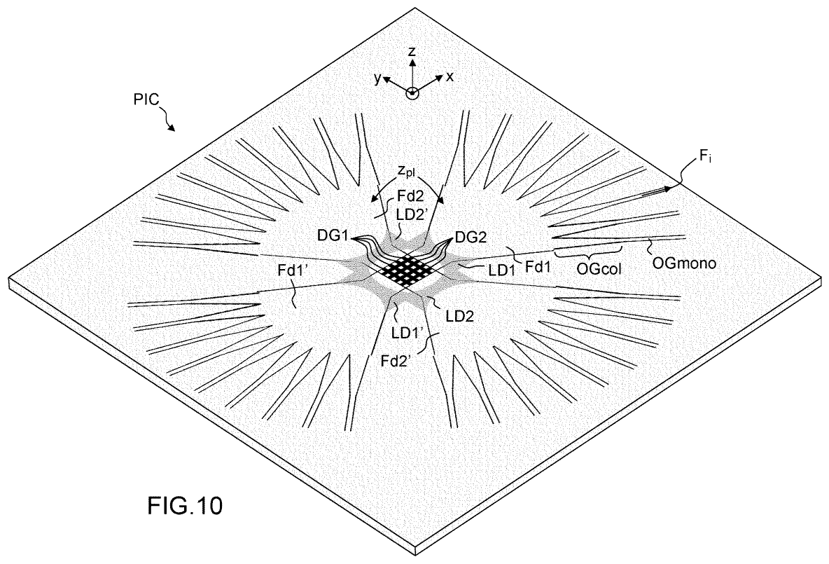

According to a second variant illustrated in FIG. 10, the diffractive device Ddiff comprises two superimposed diffraction gratings DG1, DG2 having plane fringes and each configured to generate two diffracted beams, respectively (Fd1, Fd1′) and (Fd2, Fd2′) propagating in two opposite directions. The respective fringes of the two gratings are perpendicular to one another. Here, there are 4 zones of free propagation and the conversion device comprises four divergent lenses LD1, LD1′, LD2, LD2′ positioned on the respective paths of the four diffracted beams upstream of the zones of free propagation. Letting N be the total number of single-mode guides OGmono, there are N/4 guides per direction here. In this variant, the incident beam preferably illuminates Ddiff with a normal incidence so that the Bragg condition is verified for the 4 diffracted beams. The benefit of this configuration is that, because of the presence of two perpendicular gratings, the structuring of the incident beam along Y is reproduced by diffraction on DG1 (diffraction along X and −X), and the structuring of the incident beam along X is reproduced by diffraction on DG2 (diffraction along Y and −Y). The modal structure along the two directions X and Y is present in the beams diffracted by this architecture. Furthermore, the architecture with two perpendicular gratings may potentially handle both directions of polarization of the incident beam.

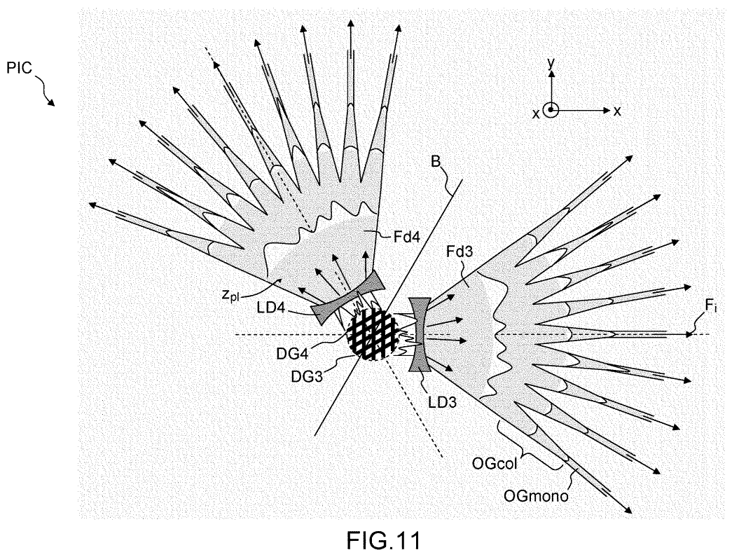

According to a third variant illustrated in FIG. 11, the diffractive device Ddiff comprises two diffraction gratings DG3, DG4 having plane fringes and each configured to generate a single diffracted beam and so that the two diffracted beams propagate in two non-collinear and non-orthogonal directions. For this purpose, the plane fringes form an angle other than 90° with one another. The conversion device comprises two divergent lenses LD3, LD4 positioned on the respective paths of the two diffracted beams Fd3 and Fd4 upstream of the zones of free propagation. There are N/2 guides OGmono per direction. The advantage of this configuration is that the Bragg condition is able to be complied with simultaneously for both gratings with a beam incident along the bisecting plane defined by the straight line B and the axis Z. This configuration is thus compatible with an oblique incidence in this plane.

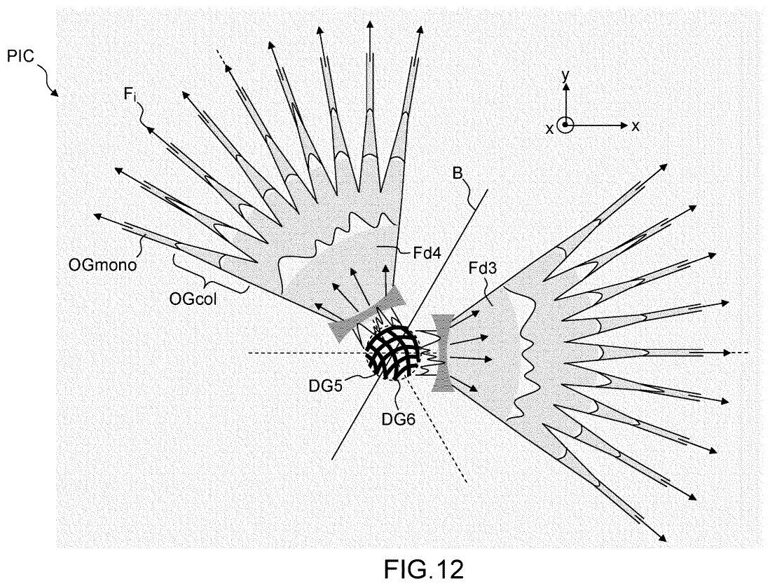

According to a fourth variant illustrated in FIG. 12, the diffractive device Ddiff comprises two diffraction gratings DG5, DG6 each having curved fringes and each configured to generate a single diffracted beam and so that said two diffracted beams propagate in two non-collinear and non-orthogonal directions. For this purpose, the curved fringes form an angle other than 90° with one another. This configuration is compatible with an oblique incidence in the bisecting plane.

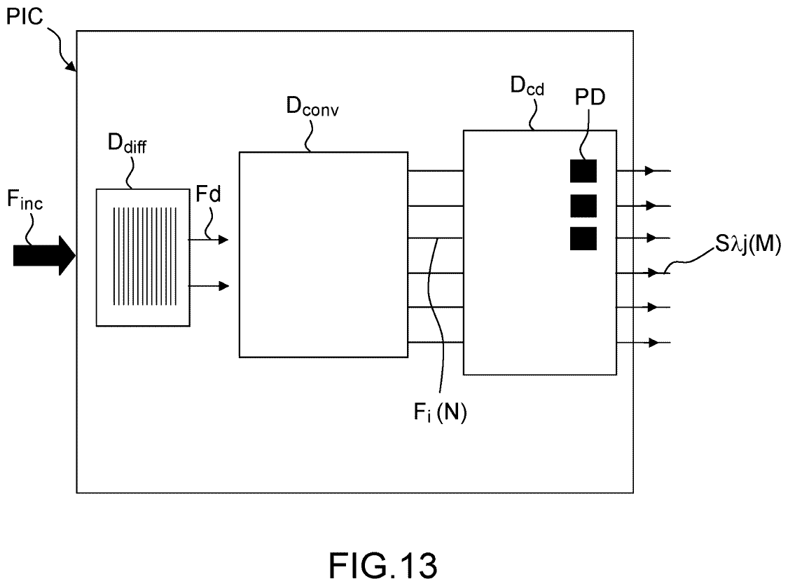

According to one embodiment illustrated in FIG. 13, the planar photonic circuit according to the invention furthermore comprises an integrated device Dcd for combining and detecting said single-mode sub-beams Fi, Dcd comprising at least one photodetector, a plurality of photodetectors in most cases. The aim is to recover the information that modulates the incident beam. Electrical signals are recovered at the output of Dcd, one signal Sλj per wavelength λj in the case of a WDM link (coherent or incoherent recombination), a single electrical signal for single-λ, coherent detection or two electrical signals at the output of the two balanced detectors in the case of I/Q coherent detection.

The PIC achieves monolithic integration of the spatial mode demultiplexer and the one or more detectors. Integrating all of the reception functionalities (coupling/spatial demultiplexing/recombination/detection) in one and the same circuit makes the PIC according to the invention extremely compact, with a compactness that goes well beyond the approaches from the prior art, and entirely relevant for embedded applications. One field of use for the PIC according to the invention is that of free-space communications in the space sector (earth-satellite), or that of communication between carriers in the terrestrial, naval or aerial sectors. The compactness of the reception system according to the invention means that the solution may be used for inter-drone communications.

Moreover, the direct integration of the multimode reception function on one and the same photonic chip avoids optical coupling losses from the receiver to the detector.

Furthermore, the coherent or incoherent recombination of the modulated sub-beams makes it possible to drastically reduce fading of the communication signal induced by the rapid exchanges of energy between spatial modes, typically due to atmospheric turbulence.

Finally, another advantage of the PIC integrating everything to do with reception is that of allowing integrated balancing of the optical paths of each sub-beam up to the combination, thereby making it possible to handle a large bandwidth, and notably allowing the PIC according to the invention to be used for wavelength multiplexing formats. For this purpose, the combining and detecting device Dcd furthermore comprises a plurality of delay lines LR configured to equalize the optical or mixed optical/electrical paths of the single-mode sub-beams, considered from the position of the one or more superimposed diffraction gratings and to a location where the signal carrying information associated with a single wavelength and integrating the contribution of all of the single-mode sub-beams is generated. A delay line is for example a spiral delay line.

The location of the end of the path to be equalized with the other paths is different depending on the type of recombination. Let us consider a WDM link in which the incident beam contains M modulated wavelengths λj. The various wavelengths λj (carriers) are for example separated by a frequency Δv and modulated with an RF signal of bandwidth Δf.

Each type of recombination is compatible with all spatial demultiplexer variants [Ddiff+Dconv].

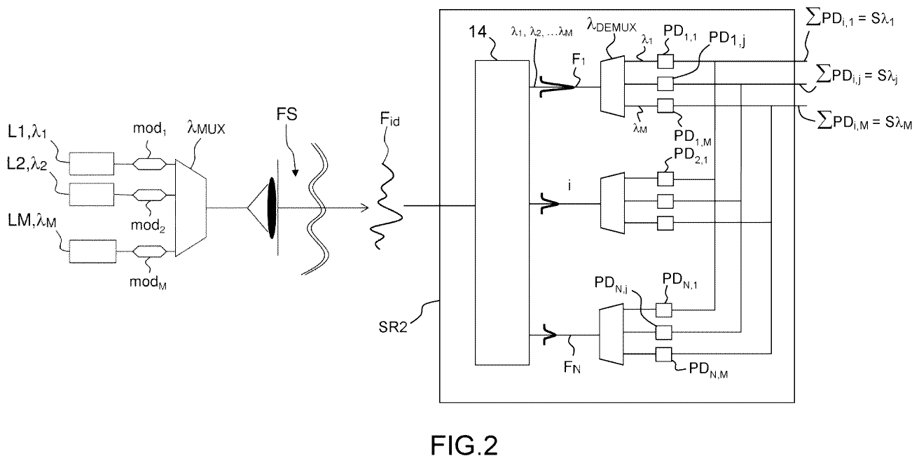

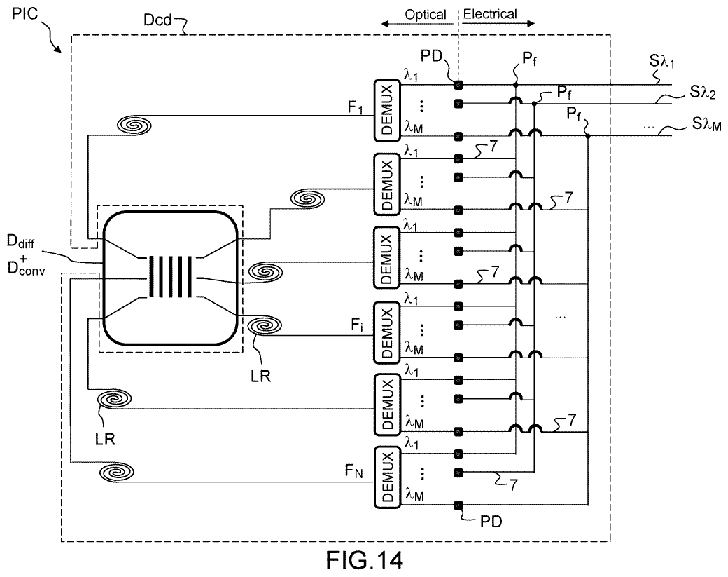

According to a first embodiment illustrated in FIG. 14, an incoherent recombination is carried out, the generic architecture of which is illustrated in FIG. 2. This example integrates the first variant of Ddiff and carries out demultiplexing on 6 (2×3) spatial modes. In the incoherent detection, electrical detection is carried out on each of the optical carriers, and then the electrical signals (photocurrents) are summed. The combining and detecting device Dcd thus comprises a plurality (N) of wavelength demultiplexers DEMUX respectively coupled to the plurality (N) of single-mode waveguides Fi. It also comprises a plurality of photodetectors PD coupled to the M outputs of each of the N demultiplexers, that is to say M×N photodetectors and electrical tracks 7 configured to sum, for each wavelength, the signals coming from the photodetectors. There are again M electrical signals Sλj integrating the contributions of each of the spatial modes at output.

The paths to be equalized are in this case mixed optical/electrical and the location of the electrical summing is the point denoted Pf in the figure, which includes all of the contributions of the signals coming from the photodetectors associated with one and the same wavelength. The equalization is carried out with the delay lines LR.

In the incoherent case, the paths have to be equalized with an accuracy related to the modulation frequency Δf. Letting c be the speed of light in a vacuum, n be the index of the propagation medium (guiding layer) and ΔL be the maximum difference in length between two paths:

$$\vert 2 \cdot \frac{Δ f \cdot n \cdot Δ L}{c} \vert ≪ 1$$

Taking for example Δf=10 GHz and Δv=300 GHz, an accuracy ΔL<<3 cm is needed.

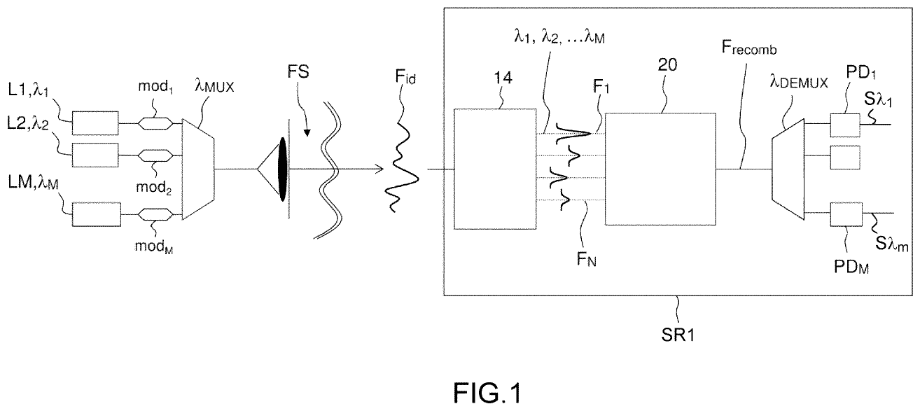

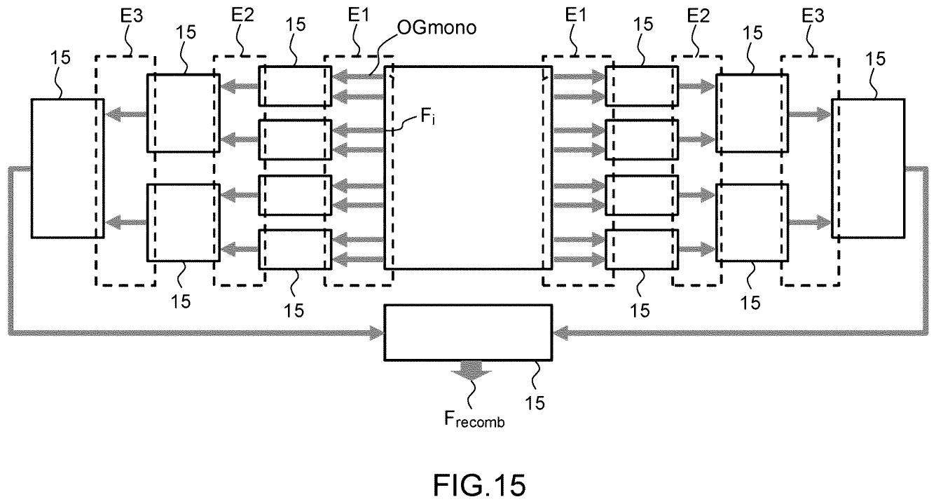

According to a second embodiment, a coherent recombination is carried out, the generic architecture of which is illustrated in FIG. 1. In this recombination, the respective phases and amplitudes of the single-mode beams are adjusted to make them into a constructive optical sum Frecomb and then, after wavelength demultiplexing, the optical signal associated with each wavelength is recovered on a photodetector. The constructive optical sum is typically carried out using a cascade architecture as illustrated in FIG. 15, based on an elementary coherent recombination device 15 that recombines the beams in pairs. The optical lengths of the paths connecting the successive coherent combination stages (E1, E2, . . . ) are equalized. The output of the last combination element (beam Frecomb) is connected to a wavelength multiplexer Demux, a detector PDj being connected to each of the outputs in order to convert the modulation signal into the electrical domain.

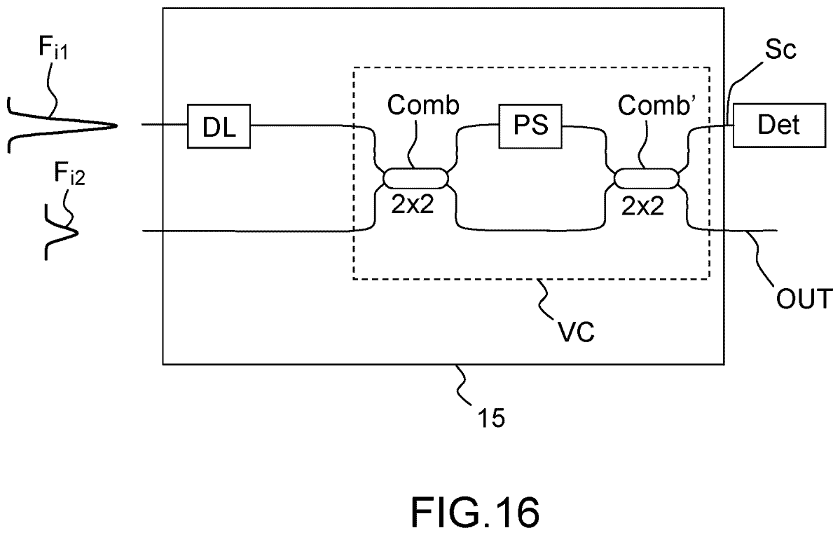

According to one embodiment, the device 15 is an integrated interferometer as illustrated in FIG. 16 and described in abovementioned document US 2020-0195355. The optical beams Fi of the single-mode channels OGmono are optically summed in pairs by way of the integrated interferometer 15, which comprises a first controllable phase shifter element PS on at least one of the arms, and a second controllable phase shifter element DL upstream of at least one of the inputs. More precisely, the elementary device 15 comprises a variable coupler VC comprising a first 2×2 combiner Comb, the phase modulator PS and a second 2×2 combiner Comb′, in accordance with a Mach Zehnder or MZI interferometer architecture. The first phase shifter PS may be positioned anywhere on the 2 arms of the MZI because the two inputs Fi1 and Fi2 are mixed following the first combiner Comb. The second combiner Comb′ has a main output that constitutes the output Out of the elementary device 15 and delivers the output beam, and a complementary output Sc that delivers a beam complementary to the output beam. A control detector Det is connected to the complementary output Sc.

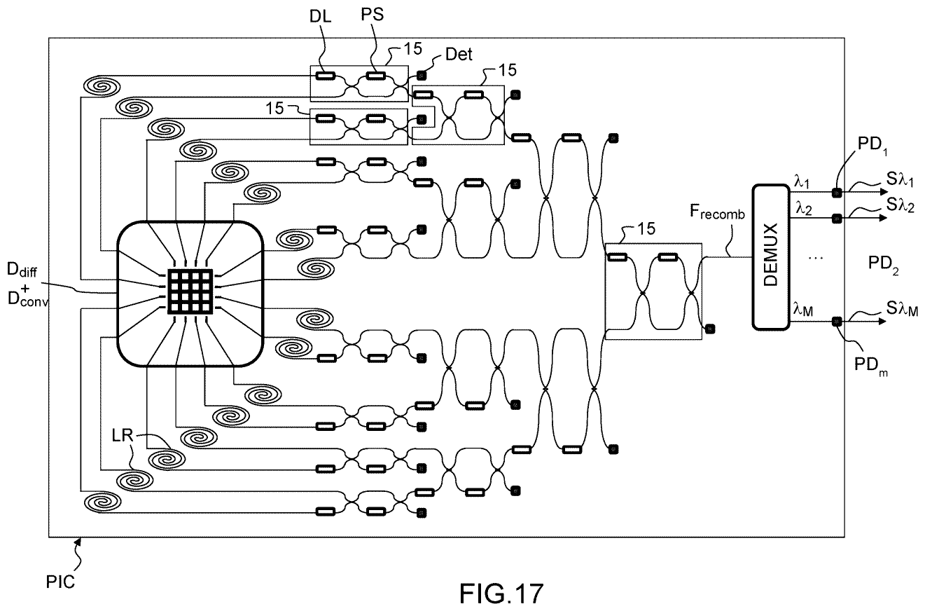

FIG. 17 illustrates a planar photonic circuit according to the invention that carries out spatial demultiplexing on 16 single-mode beams (N=16) and coherent recombination with a plurality of interferometers 15 as illustrated in FIG. 16. The circuit PIC in the figure therefore comprises a plurality of elementary coherent recombination devices 15 arranged in cascades so as to obtain a recombined beam Frecomb, the single-mode waveguides being coupled in pairs to the elementary coherent recombination devices of the first stage E1 of said cascade. It also comprises a wavelength demultiplexer Demux and a plurality of photodetectors PDj (M photodetectors) coupled to the outputs of the demultiplexer.

The equalization of the paths for the coherent recombination is carried out with the output of the demultiplexer as the end point of each path. The phase match constraint on the various paths is expressed as follows:

$$\vert 2 \cdot \frac{Δ f \cdot n \cdot Δ L}{c} \vert ≪ 1$$

Taking for example Δv=300 GHz, there is a need for an accuracy:

ΔL<<c/2·Δv·n=1 mm.

Typically, to have effective combination, ΔL must be of the order of c/20·Δv·n

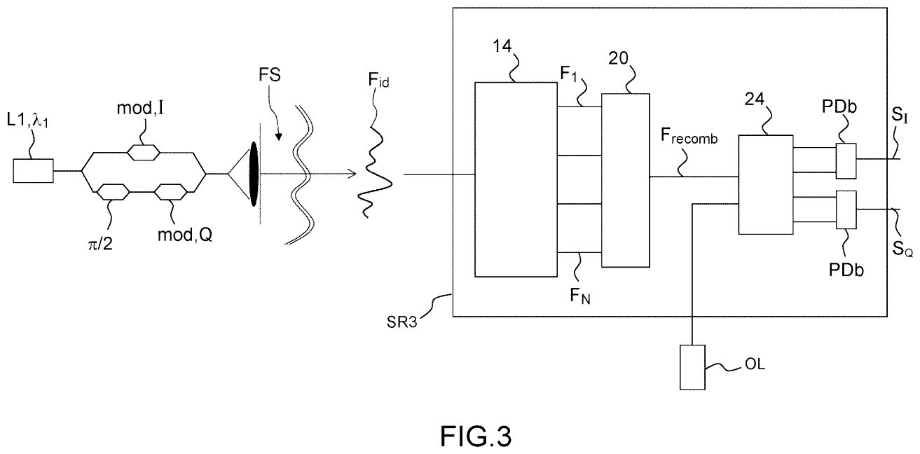

According to one embodiment, the PIC according to the invention carries out single-wavelength detection and coherent recombination for an application such as a coherent optical communication application (where the two quadratures of the electric field are modulated) or a lidar application. The PIC according to the invention in this case comprises a mixer configured to mix the recombined beam Frecomb with a local oscillator, the photodetector being a balanced photodetector. Preferably, the mixer has 4 outputs coupled to two balanced photodetectors so as to carry out in-phase and quadrature detection (see the generic architecture in FIG. 3).

1. A planar photonic circuit (PIC) for demultiplexing a multimode incident optical beam into a plurality of single-mode sub-beams, comprising a guiding layer (GL), the planar photonic circuit comprising:
an integrated diffractive device (Ddiff) comprising a coupling diffraction grating or two superimposed coupling diffraction gratings (DG0, DG1, DG2, DG3, DG4, DG5, DG6), configured to couple the multimode optical beam into the guiding layer of the planar photonic circuit and to generate two or four diffracted beams (Fd1, Fd1′, Fd2, Fd2′, Fd3, Fd4),
an integrated conversion device (Dconv) comprising:
zones of free propagation (Zpl), a zone of free propagation being associated with each of the diffracted beams, the conversion device furthermore being configured such that a diffracted beam diverges as it propagates through the associated zone of free propagation,
a plurality of collecting waveguides (OGcol) arranged downstream of each zone of free propagation and
a plurality of single-mode waveguides (OGmono),
a collecting waveguide being coupled to a single-mode waveguide and being configured to adiabatically transform a fraction of the multimode optical beam collected locally by said collecting waveguide into an optical beam in a fundamental mode of said single-mode waveguide, so as to generate said plurality of single-mode sub-beams (Fi).

2. The planar photonic circuit as claimed in claim 1, wherein:
the diffractive device comprises a single diffraction grating (DG0) having plane fringes and generating two diffracted beams (Fd1, Fd1′) propagating in two opposite directions,
the conversion device comprises two divergent lenses (LD1, LD1′) positioned on the respective paths of the two diffracted beams upstream of the zones of free propagation.

3. The planar photonic circuit as claimed in claim 1, wherein:
the diffractive device comprises two diffraction gratings (DG1, DG2) having perpendicular plane fringes, and each configured to generate two diffracted beams (Fd1, Fd1′, Fd2, Fd2′) propagating in two opposite directions,
the conversion device comprises four divergent lenses (LD1, LD1′, LD2, LD2′) positioned on the respective paths of the four diffracted beams upstream of the zones of free propagation.

4. The planar photonic circuit as claimed in claim 1, wherein:
the diffractive device comprises two diffraction gratings (DG3, DG4) having plane fringes and each configured to generate a single diffracted beam (Fd3, Fd4) and so that said two diffracted beams propagate in two non-collinear and non-orthogonal directions,
the conversion device comprises two divergent lenses (LD3, LD4) positioned on the respective paths of the two diffracted beams upstream of the zones of free propagation.

5. The planar photonic circuit as claimed in claim 1, wherein:
the diffractive device comprises two diffraction gratings (DG5, DG6) having curved fringes and each configured to generate a single diffracted beam and so that said two diffracted beams propagate in two non-collinear and non-perpendicular directions,
the conversion device comprises two divergent lenses positioned on the respective paths of the two diffracted beams upstream of the zones of free propagation.

6. The planar photonic circuit as claimed in claim 1, furthermore comprising an integrated device (Dcd) for combining and detecting said single-mode sub-beams, comprising at least one photodetector.

7. The planar photonic circuit as claimed in claim 6, wherein the integrated combining and detecting device (Dcd) furthermore comprises a plurality of delay lines (LR) configured to equalize the optical or mixed optical/electrical paths of the single-mode sub-beams, considered from the position of the one or more superimposed diffraction gratings and to a location where a signal carrying information associated with a single wavelength and integrating the contribution of all of the single-mode sub-beams is generated.

8. The planar photonic circuit as claimed in claim 6, wherein the integrated combining and detecting device comprises:
a plurality of wavelength demultiplexers (Demux) respectively coupled to the plurality of single-mode waveguides,
a plurality of photodetectors coupled to the outputs of said demultiplexers,
electrical tracks configured to sum, for each wavelength, the signals coming from the photodetectors.

9. The planar photonic circuit as claimed in claim 7, wherein said location is the one for which the electrical summing (PF) includes all of the signals coming from the photodetectors associated with one and the same wavelength.

10. The planar photonic circuit as claimed in claim 7, wherein the combining and detecting device comprises:
a plurality of elementary coherent recombination devices (15) arranged in cascades so as to obtain a recombined beam (Frecomb), the single-mode waveguides being coupled in pairs to the elementary coherent recombination devices of the first stage of said cascade,
a wavelength demultiplexer (Demux),
a plurality of photodetectors (PDj) coupled to the outputs of the demultiplexer.

11. The planar photonic circuit as claimed in claim 10, wherein the elementary coherent recombination device comprises an integrated interferometer comprising a first (PS) and a second (DL) phase shifter element.

12. The planar photonic circuit as claimed in claim 7, wherein said location is the output of the wavelength demultiplexer.

13. The planar photonic circuit as claimed in claim 10, wherein the combining and detecting device furthermore comprises a mixer (MMI) configured to mix the recombined beam with a local oscillator, the photodetector being a balanced photodetector.

14. The planar photonic circuit as claimed in claim 13, wherein the mixer has 4 outputs coupled to two balanced photodetectors so as to carry out in-phase and quadrature detection.
